(19) United States
(12) Patent Application Publication
(10) Pub. No.: US 2012/0206496 A1
(43) Pub. Date: Aug. 16, 2012

(54) SYSTEM FOR IMAGING PRODUCT LAYOUT

(76) Inventor: Ronald S. Cok, Rochester, NY (US)

(21) Appl. No.: 13/025,220

(22) Filed: Feb. 11, 2011

(51) Int. Cl. G09G 5/00

(52) U.S. Cl. 345/672

(57) ABSTRACT

A computer system comprising storage for three or more digital images and for a digital representation of an image product. A program stored by the system and executed by a processor of the system automatically digitally places the digital images into different display locations in the digital representation of the image product. User selected images and corresponding new display locations are received by the program to automatically place selected digital images into selected new locations while displaced images are placed in new locations and the image arrangement is realigned.

### CROSS REFERENCE TO RELATED APPLICATIONS

U.S. patent application Ser. No. ______, (Docket 96489) entitled “IMAGING PRODUCT LAYOUT METHOD” filed concurrently herewith is assigned to the same assignee hereof, Eastman Kodak Company of Rochester, N.Y., and contains subject matter related, in certain respect, to the subject matter of the present application. The above-identified patent application is incorporated herein by reference in its entirety.

### FIELD OF THE INVENTION

The present invention relates to combining images on image-bearing products to provide an improved aesthetic combination.

### BACKGROUND

Products that include images are a popular keepsake or gift for many people. Such products typically include a picture taken by an individual that is inserted into a product intended to enhance the product, the presentation of the image, or to provide storage for the image. Examples of such products include picture albums, posters, picture calendars, picture mugs, picture ornaments, picture mouse pads, and picture post cards.

Images can also be combined with other images, for example templates including background images and one or more image openings into which an individual's image can be inserted, either mechanically or electronically with a computer, to form a combined image that displays the individual's image in a pleasing or preferred manner. These image products can be provided in hard-copy form, for example as a printed photo-book, or in electronic form presented by a computer, for example in an on-line album. Imaging products can also include multi-media products, especially when in electronic form, that, for example, can include motion image sequences or audio tracks.

Designing multi-image and multi-media products can be a daunting challenge for users, particularly when the products include personal images. Software tools that execute on computers can assist users in designing customized multi-image products. Such software products can execute, for example, on home computers. Alternatively, on-line design and printing services accessible through an internet browser interface can assist users in designing and printing a multi-image product.

Such software and internet design tools can enable users to position personal images or other multi-media elements in a multi-image product, such as a photo-book or collage. For example, users can drag-and-drop image icons into openings in a visual representation of a multi-image product to specify the multi-image product, for example as is done in the on-line image printing business of the Kodak Gallery. However, such an approach to designing a multi-media image product can be very difficult, as a very large number of different layouts are available and selecting from among them can be tedious, time-consuming, and anxiety-inducing for a user. Alternatively, software and internet design tools include automated layout software that will position a user's images in various locations in a template without intervention, as is taught for example in U.S. Pat. No. 7,340,676 which is incorporated herein by reference in its entirety. Such automated layout methods, however, do not always select the best or preferred layout for a product as desired by a user.

There is a need therefore, for an improved method for laying out multiple images on one or more pages or within an image product.

### SUMMARY OF THE INVENTION

In accordance with a preferred embodiment of the present invention, there is provided a computer implemented method of automatically digitally placing the digital images into different display locations in the digital representation of the image product. The program includes instructions for receiving a selection input for a first selection of one of the digital images, an input indicating a new display location for the first selected digital image, whereby the program automatically digitally places the first selected digital image into the new display location and automatically digitally relocates displaced ones of the remaining digital images into remaining display locations. A digital representation of a completed image product is displayed on a monitor or digital display and it includes displaying the first selected digital image in the new display location. The stored file that includes the digital representation of the completed image product can then be transmitted over a network. The images handled by the computer system include multi-media images that include motion images or sound, or both. The computer program of the computer system relocates images as selected by the user and automatically relocates the display locations. The computer program further includes capabilities for receiving an input for a second selection of another displayed digital image and an input for an another display, wherein the other digital image is automatically digitally placed in the display location and the displaced ones of the remaining digital images are automatically relocated, except that the first selected digital image remains in place. Different sizes, resolutions, aspect ratios, and orientations of the received digital images can be modified by the program in order to fit the display locations. Borders can be carried together with the received digital images during replacement as well. Templates can be separately stored that comprise a number of openings for use with the received digital images. Cropping images and retrieving areas of digital images that were cropped out can also be performed. The placement of digital images includes placements where portions of the digital images overlap. Thus, the display locations include overlapping arrangements.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 illustrates a set of images having different sizes and aspect ratios useful in understanding different embodiments of the present invention;

FIGS. 2-6 are a successive series of image layouts illustrating a method according to an embodiment of the present invention;

FIGS. 7-11 are a successive series of image layouts illustrating a method according to another embodiment of the present invention;

FIGS. 12-14 are a successive series of image photo-collage layouts illustrating a method according to an embodiment of the present invention;

FIGS. 15-16 are a successive series of image layouts with borders illustrating a method according to an embodiment of the present invention;

FIG. 17 is an image photo-collage layout illustrating a method according to an embodiment of the present invention;

FIG. 18 illustrates a template layout having openings of different sizes and aspect ratios useful in understanding different embodiments of the present invention;

FIGS. 19-21 illustrate a successive series of image template assignments for the template layout of FIG. 18 illustrating a method according to an embodiment of the present invention;

FIG. 22 illustrates a two-page template layout useful in understanding different embodiments of the present invention;

FIGS. 23A-B is a flow chart illustrating a method according to an embodiment of the present invention;

FIG. 24 illustrates a set of images having the same sizes and aspect ratios useful in understanding different embodiments of the present invention;

FIGS. 25-28 illustrate a successive series of image template assignments for the template layout of FIG. 24 illustrating a method according to an embodiment of the present invention;

FIGS. 29A and 29B illustrate an image product template and a composited image product according to an embodiment of the present invention;

FIGS. 30A and 30B illustrate image layouts according to an embodiment of the present invention; and

FIGS. 31 and 32 illustrate computing equipment useful for different embodiments of the present invention.

### DETAILED DESCRIPTION OF THE INVENTION

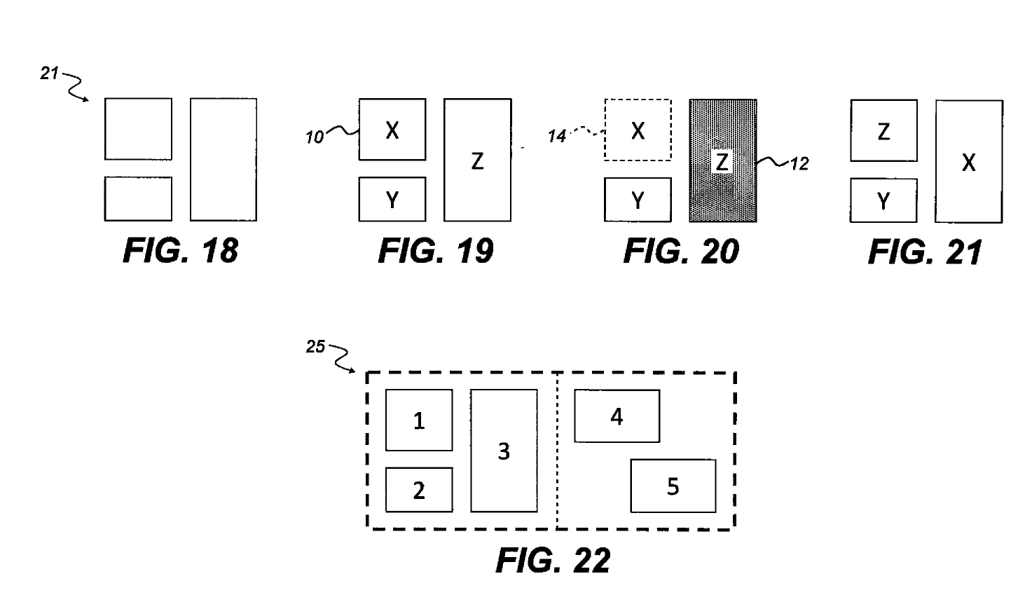

According to a preferred embodiment of the present invention, an image product is a product that includes a user's personalized images incorporated into an image-related object, such as for example a photo-book, a picture greeting card, a picture mug, or other image-related product. The images can be positioned in specified pre-determined locations or can be adaptively positioned according to the sizes, aspect ratios, orientations and other attributes of the images. Likewise, the image sizes, orientations, or aspect ratios included in the image product can be adjusted, either to accommodate pre-defined templates with specific pre-determined openings or adaptively adjusted for inclusion in an image product. In an embodiment of the present invention illustrated in FIG. 29A, an image product template 21A includes an image area 27 with a background. In the example of FIG. 29A, the image template does not prescribe the locations of images in the image area 27. In other embodiments, for example as illustrated in FIG. 18, the image locations and aspect ratios are pre-defined.

According to various embodiments of the present invention, a multi-media product is a product that includes a user's personalized images incorporated into an image-related object, such as for example a photo-book, a greeting card, a mug, or other image-related product. The images can be still images or image sequences, motion images such as videos, and the multi-media product can include other media features, for example audio tracks, sounds, or sound sequences. A multi-media product can be a hard-copy product, for example a printed image together with an audio playback capability, or an electronic product, for example in an on-line album with still images, multiple still images, image sequences, motion images, sounds, a sequence of sounds, or audio tracks, or all of these. For simplicity and clarity of discussion, still images are described herein, but it is to be understood that the methods and objects described can include multi-media products that include images and can be either hard-copy or electronic and that the present invention includes these various embodiments.

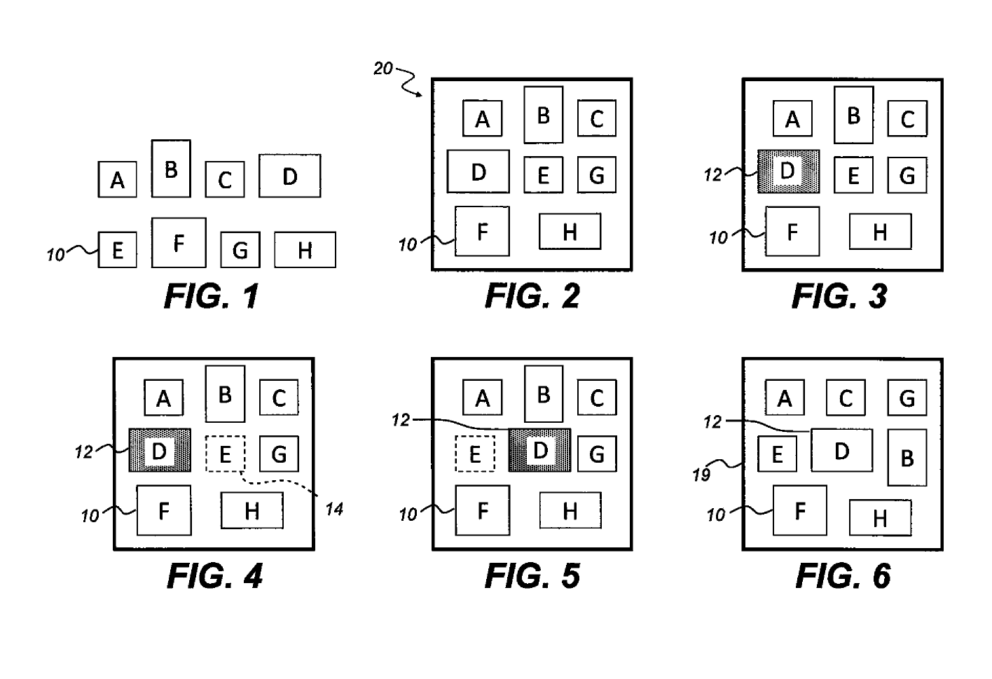

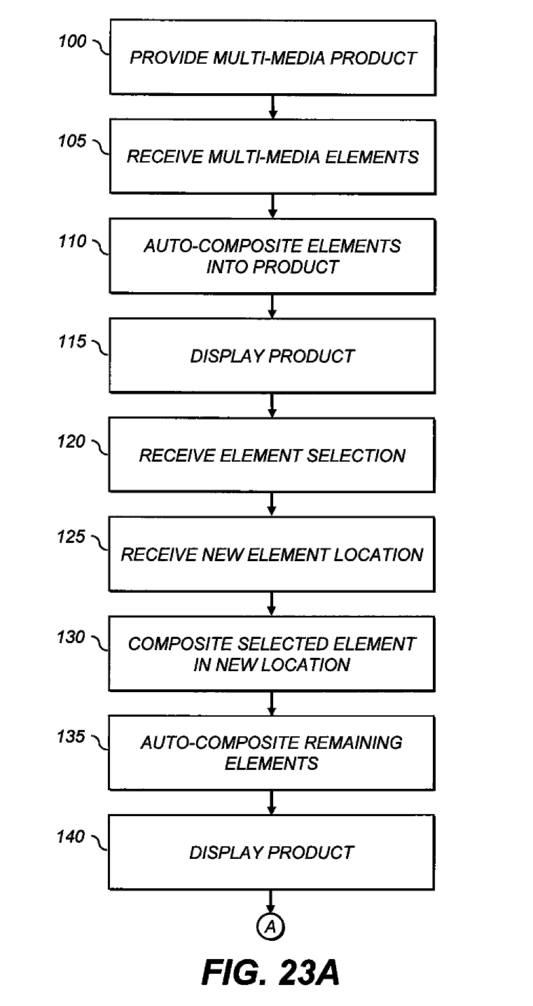

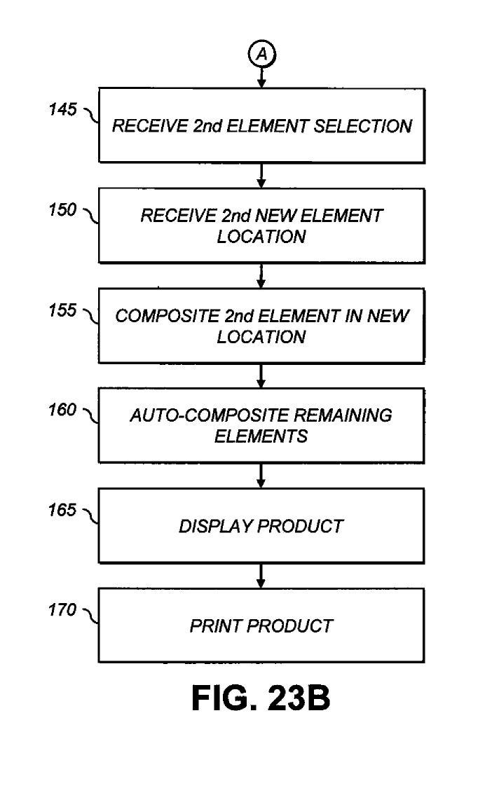

According to an embodiment of the present invention, and as illustrated in FIGS. 1-6 and in FIG. 23A, a method of making a multi-media product comprises the steps of providing a multi-media product having a display area for displaying three or more multi-media elements 10 in step 100. FIG. 1 illustrates a collection of eight images labeled A, B, C, D, E, F, G, and H. The images have different sizes and aspect ratios. This embodiment of the present invention is addressed to making an imaging product which incorporates the images. Three or more user digital multi-media elements 10 are received in step 105. The multi-media elements 10 each include one or more images. The received images 10 are automatically positioned and composited into different display locations in an image layout 20 in the display area in step 110 and as illustrated in FIG. 2. A variety of algorithms for positioning and compositing images are known in the art and are practiced, for example, in the Kodak Gallery. The composited product is displayed, for example in a graphic user interface to a user, in step 115. If the user is satisfied with the result, the product can be accepted. However, according to a preferred embodiment of the present invention, users can prefer to further customize the automatically laid-out image product to improve its aesthetic appeal or to personalize it in such a way as to enhance the emotional value of the product. For example, one of the images can have a particularly strong emotional value to a user or recipient and the user can desire to place that image in a more prominent location, for example in the center of the image-product display area.

Therefore, according to an embodiment of the present invention, one or more image element selections are received in step 120, for example from a user who selects a desired image 12 with a pointing device such as a mouse-controlled cursor or pointer in the graphic user interface (FIG. 3). In step 125 a desired location 14 (FIG. 4) for the selected image 12 is also received. The desired location can also be selected by a user with a mouse-controlled pointer in a graphic user interface. Alternatively, the desired location (e.g. the center of the display area) can be pre-determined and provided by the designers of the layout method. In further embodiments of the present invention, multiple images with corresponding locations can be selected.

The selected image 12 is then moved to the selected location as shown in FIG. 5 and the image in the selected location moved to the former location of the selected image. Note that the illustration of FIG. 5 is not necessarily presented to the user; it is included in the description for clarity. The layout of FIG. 5 does not actually need to be created or displayed. The selected images are re-positioned as indicated and the remaining images automatically positioned and re-composited in the image product with the constraint that the selected image is in the selected location 14 in step 130 and as illustrated in FIG. 6. Note that in the image product 19 of FIG. 6, the locations of some of the images have been changed with respect to the locations of FIG. 2. According to an embodiment of the present invention, and as shown in FIG. 6, the exchanged image 14 of FIG. 4 is located in the former location of image 12 (on the left edge). Alternatively, the location of image 14 could be relocated elsewhere in the image product 19.

Thus, the method of a preferred embodiment of the present invention allows the layout work to be automated but constrained by the personalized desires of a user. In particular, in a very simple way, the user sets limits on the layout parameters of the automated layout system by requiring selected images to be positioned in desired locations. The re-positioned images are then displayed to the user in step 140 and, if acceptable, provided to the user in step 170, for example by printing, communicating, storing the image product as a specification, or rendering and storing a rendered image of the image product as a single file either electronically or in hard-copy form for example, as illustrated in FIG. 29B for the image product template of FIG. 29A.

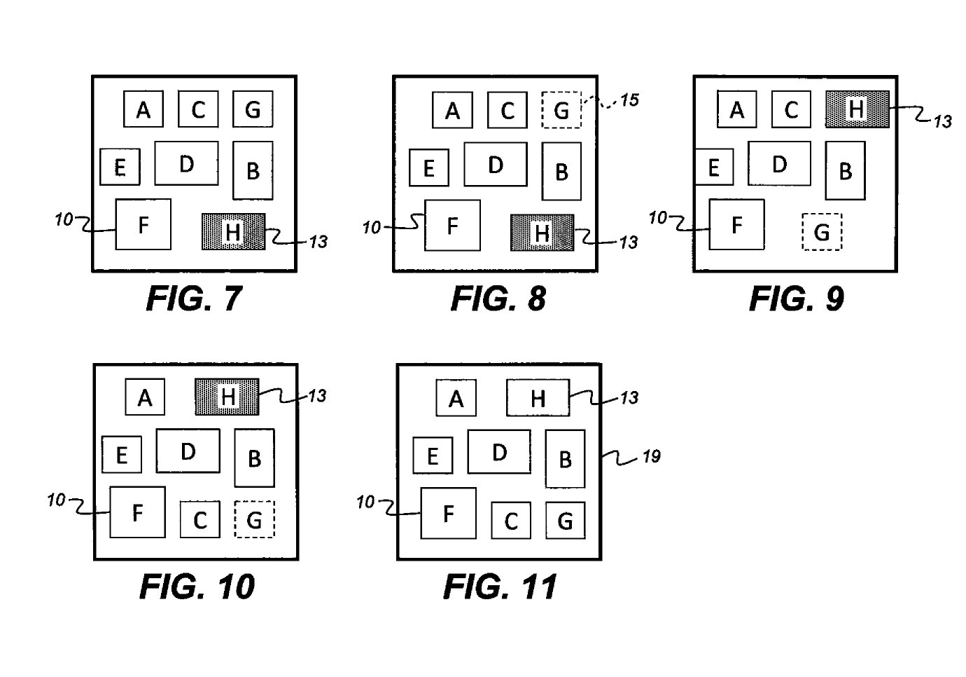

The process described is repeated as illustrated in FIGS. 7 to 11 and in FIG. 2313. A user can prefer to specify the locations of more than one image within an image product. The images and their locations can be specified sequentially to provide a simple-to-understand process that provides automated support for the tedious task of laying out many images in an image product but that also provides desired personalization.

A selection of one or more second user digital multi-media element(s) 13 of the composited plurality of user digital multi-media elements in the display area different from the first user digital multi-media element(s) are received in step 145 (FIG. 7). An indication of a second new location for each of the selected second user digital multi-media element(s) in the display area different from the first new location of the second user digital multi-media element is provided or received in step 150 (FIG. 8). The second user digital multi-media element(s) are automatically positioned and composited into the second new location(s) in step 155 as shown in FIG. 10 and the remaining user digital multi-media elements are automatically positioned and composited into the display area in different locations from the new location without changing the user-selected location(s) of the first user digital multi-media element(s) in step 160 as shown in the image product 19 of FIG. 11. As with the illustration of FIG. 5, the illustration of FIG. 10 is provided for understanding; the corresponding image layout does not actually need to be made or shown to a user. The resulting composited user digital multi-media elements are then displayed in the new location(s), the second new location(s), and the different locations in the display area in step 165 and as shown in FIG. 11. The multi-media product can then be provided (e.g. by printing) as described above in step 170.

There are a variety of methods that can be employed to lay out images in a multi-image product. If template openings are used, the coordinates of the point in the center of the openings can be exchanged. By exchanging the locations of the openings' center point, the positions of the template openings are likewise exchanged and aligned to the center of each exchanged opening. However, in cases for which the aspect ratio of exchanged images differs, a simple exchange of the images with the same center points can lead to one image obscuring another or variable separations between images that are not aesthetically pleasing. Hence, according to an embodiment of the present invention, the relative image locations can be adjusted after the image exchange so as to create a more pleasing effect, for example by adjusting the spacing between the images without modifying the relative locations. By not modifying the relative locations is meant that the images above, below, to the left or to the right of an image remain above, below, to the left or to the right, respectively, after an image is moved to exchange its center point or to readjust the relative spacing between the images.

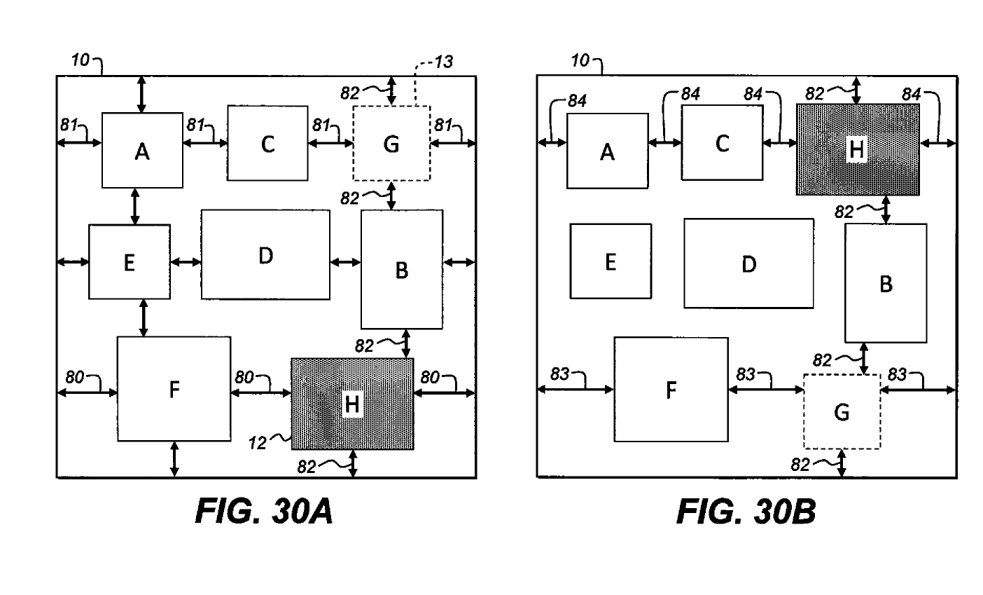

For example, referring to FIGS. 30A and 30B, in one embodiment of the present invention, equal-sized separations between some images and product edges are maintained. As shown in FIG. 30A, images F and H are separated from the edges of the multi-image product 10 and from each other by equal separation distances 80 in the horizontal direction. Images A, C, and G are separated from the edges of the multi-image product 10 and from each other by equal separation distances 81 in the horizontal direction. Images E, D, and H are likewise separated by a common distance from each other and from the multi-image product edges. In the vertical direction, images G, B, and H are separated from each other and the multi-image product edge by equal separation distances 82. Likewise, images A, E, and F are distributed evenly in the vertical direction. However, it is not always possible to evenly distribute every image in every direction if the images have different sizes or aspect ratios. For example, images C, D, and H are not equally separated vertically, nor are images C, D, and F. According to an embodiment of the present invention and as illustrated in FIG. 30B, the image H is selected and exchanged with image G; the remaining images (A, B, C, D,E, and F) are laid out again to maintain equal separation distances. The horizontal placement of images A, C, and H is adjusted to a separation distance of 84 and the horizontal placement of images F and G is adjusted to a separation distance of 83. The vertical separation distance 82 between images G, B, and H and the multi-image product 10 edges does not change since the same images (G, B, and H) are still in the same column, just in a different order. However, the center points and vertical locations of images G, B, and H are adjusted. Other image positions can also be adjusted, for example the vertical position of image D is adjusted to provide a more regular vertical separation distance between images H and F (as well as images C and G) while the horizontal position of image D is not changed.

The process of FIGS. 23A-B can be repeated as often as a user desires until a satisfactory arrangement is found. The user can start over, if desired, or repeat some steps with previously selected images to attempt new arrangements.

Because the images can have different sizes, orientations, or aspect ratios, the user selected locations can be approximate within the image product display area. For example, a selected location can be the center, edge, or corner of a display area.

Just as an image can be selected to highlight it within an image product by locating the highlighted image in a central or larger template opening, so other images could be selected to relatively diminish the appearance or importance of the image, for example by locating it in a corner or edge or in a smaller template location. Various embodiments of the present invention include both or either increasing or diminishing the apparent importance of an image by relocating the image. Graphic user interfaces, displays, pointer, and control software area all known in the art, as is automated layout software that can layout images in a display area, with or without constraints, for example as is taught in the above-referenced U.S. patent.

A wide variety of images or multi-media elements, image products, and image layouts can be employed in various embodiments of the present invention. The illustration of FIGS. 1-11 and 29A and 29B shows an image template, for example a background (FIG. 29A) with unconstrained image locations and images with a variety of image sizes and aspect ratios. In other embodiments of the present invention, the locations, aspect ratios, orientations, resolutions, or sizes are constrained in the templates or in the received image types. Thus, in various embodiments of the present invention, the sizes, resolutions, aspect ratios, or orientations of received images can be modified for inclusion into a constrained template. Correspondingly, the sizes, resolutions, aspect ratios, or orientations of template openings can be modified to match the constrained received images. In a free-form template, the images can be laid out to match the attributes of the received images.

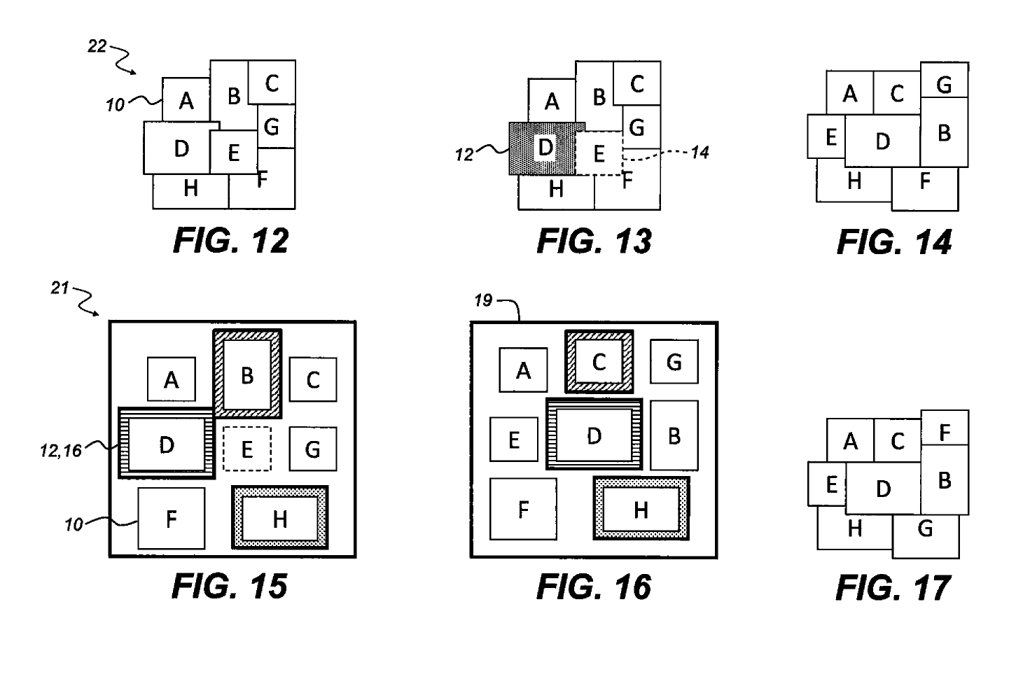

In another embodiment of the present invention, the images are positioned to form a photo-collage as shown in FIGS. 12-14. In a photo-collage, one or more images apparently obscure portions of one or more other images. In FIG. 12, an initial photo-collage layout 22 of received images 10 is automatically provided by applying a layout algorithm to the images in the desired template. A variety of layout algorithms are known in the art. For example, the SmartFit layout algorithm employed in the Kodak Gallery photobook application can be employed. Algorithms that attempt to reduce the overall white-space (space unoccupied by images) are known, as well as algorithms that use template libraries and select the best library template based on various criteria, such as aspect ratio and size. In one simple embodiment, a library template having the same number of images with the closest corresponding aspect ratios and relative image sizes is chosen. An image selection 12 and image location selection 14 are received (FIG. 13) and the photo-collage re-laid out and re-composited as illustrated in FIG. 14 and in FIG. 17.

In yet another embodiment of the present invention, images or image locations within a template can have borders associated with the image or the location. In different embodiments of the present invention, the borders can be re-positioned with the re-positioned selected images or can be left in place and re-associated with a different re-positioned image. For example, FIG. 15 illustrates an initial, automatic layout of images 10 in an image template 21. In this embodiment, the borders can be considered to be a portion of the template opening and the images inserted therein reduced in size to compensate for the reduced opening area. The layout of the template openings can proceed using known algorithms as described above. Images B, D, and H all have borders. Image D and location E are selected. The image selection and image location selection are received and the photo-collage re-laid out and re-composited as illustrated in the image product 19 of FIG. 16. As shown, the border for selected image D is re-positioned with the image. However, the border for image B stays in place and is re-associated with re-positioned image C. The border and image H are not changed. The choice as to whether a border is fixed in location can be made by the user or by default. If the border is not re-located, the template opening can be considered to be the open area in the template excluding the border. The laid-out and composited images can be displayed with their associated borders to aid users in deciding what modifications, if any are desired. Users can also specify whether the border should move with the image or whether it should remain in the defined location within the template. The layout method can include the border as part of the image (if the border is re-positioned with the image) or as part of the background template (if the border remains in the specified location).

According to another embodiment of the present invention, image templates can also have fixed locations, sizes, aspect ratios, and orientations as is illustrated in FIG. 18. FIG. 19 illustrates the result of an automated layout of received images X, Y, and Z. As shown in FIG. 20, the user selects image Z and location X, the automated layout tool then re-composites and re-lays out the images as shown in FIG. 21. If cropping or resizing is desired for an image within a specific template opening, available interactive graphic user interface tools, such as those of the Kodak Gallery, can be employed. A variety of cropping and resizing tools are known in the art, any of which can be employed.

Image products and templates can also include multiple pages, as illustrated in FIG. 22. The method of a preferred embodiment of the present invention can also be applied to individual pages or to multiple page layouts of multi-page products with multi-page templates 25 specifying multiple images on one or more pages. Free-form multi-page templates can also be employed (not shown).

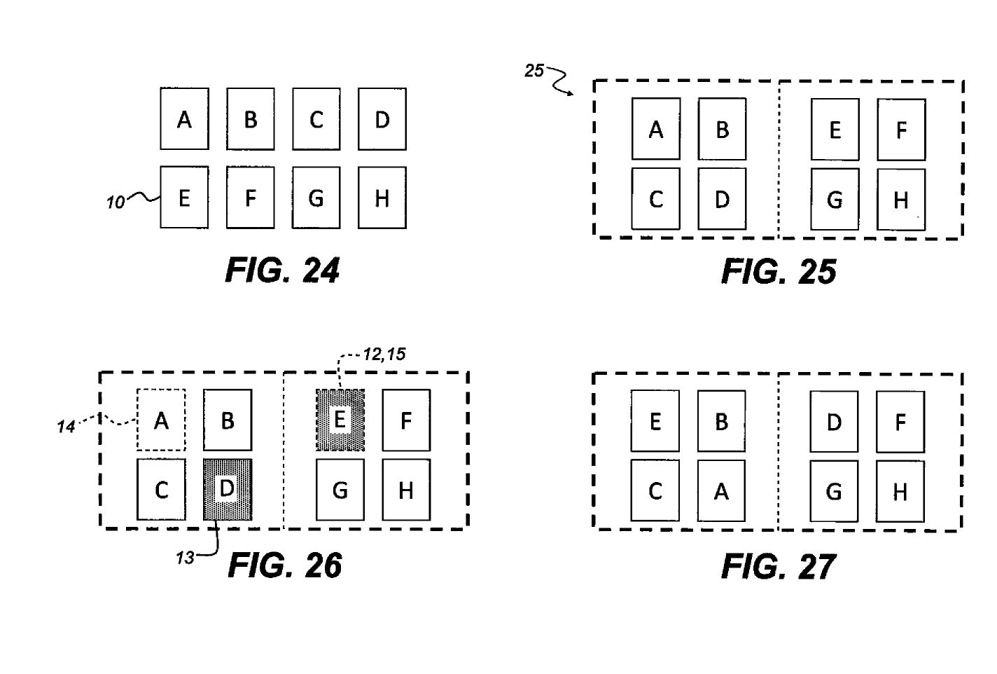

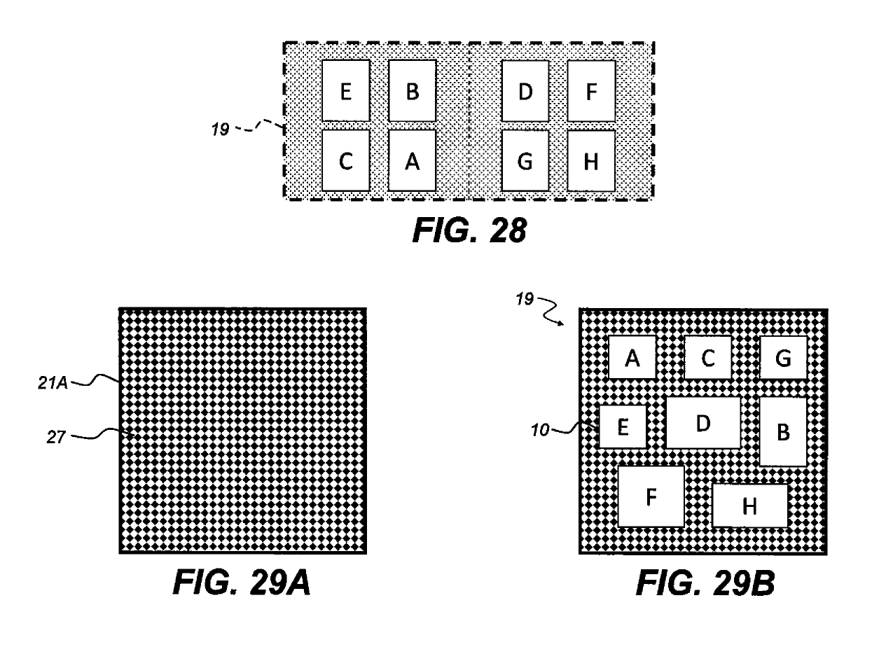

FIG. 1 illustrates an example of a preferred embodiment of the present invention wherein images have different sizes and aspect ratios. In another embodiment of the present invention illustrated in FIG. 24, images having identical sizes, orientations, and aspect ratios can be employed. Referring to FIG. 25, the images of FIG. 24 are automatically laid out in a two-page template format. Two images 12, 13 are selected and corresponding locations 14, 15 specified (FIG. 26). The selected images are then re-positioned (FIG. 27) and re-laid out as specified in an image product 19 (FIG. 28). (FIG. 27 is provided for understanding; the layout illustrated is not necessarily displayed.)

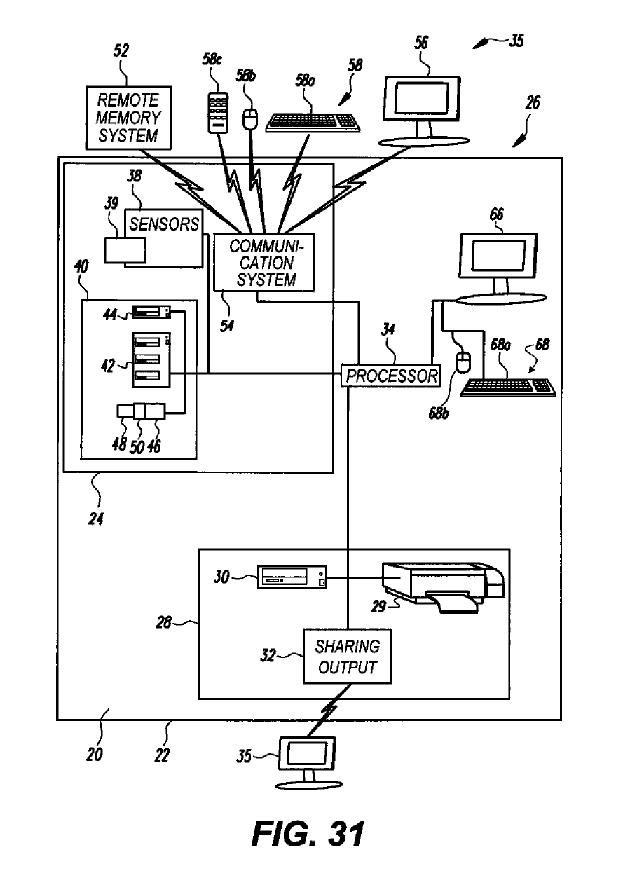

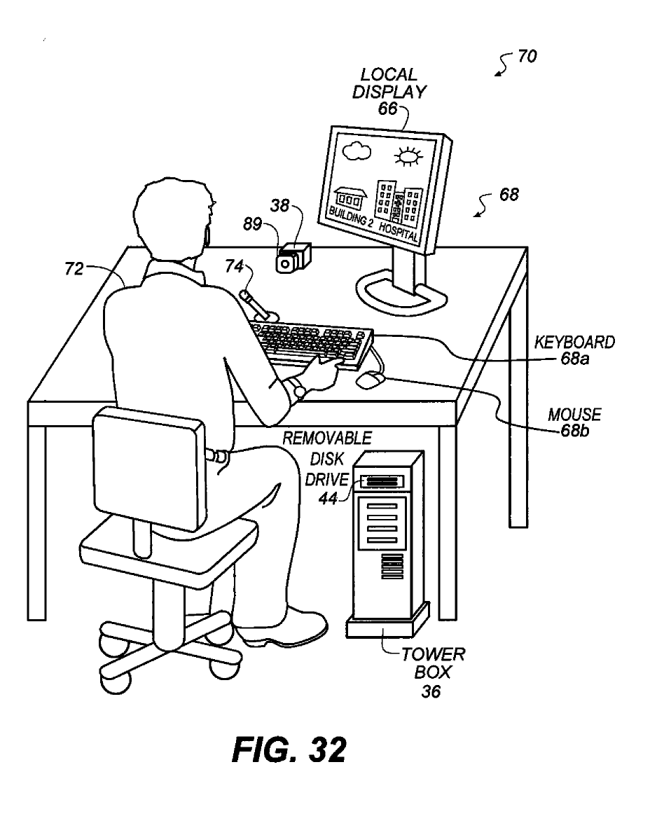

A preferred embodiment of the present invention can employ a variety of computing platforms. For example, computer servers and remote client computers useful in a preferred embodiment of the present invention are illustrated in FIGS. 31 and 32. FIG. 31 illustrates a first embodiment of an electronic system 26, a computer system, for implementing certain embodiments of the present invention for automatically generating image products and services. In the embodiment of FIG. 31, electronic computer system 26 comprises a source of content and program data files 24 such as software applications, image use profiles, user profiles, and image files, and which includes various memory and storage devices 40, a wired user input system 68 as well as a wireless input system 58, and an output system 28, all communicating directly or indirectly with processor 34. Although not shown, processor 34 is meant to illustrate typical processor system and chip components such as instruction and execution registers, an ALU, and various levels of cache memory. The source of program and content data files 24, user input system 68, or output system 28, and processor 34 can be located within a housing (not shown). In other embodiments, circuits and systems of the source of content and program data files 24, user input system 68 or output system 28 can be located in whole or in part outside of a housing.

The source of content or program data files 24 can include any form of electronic, optical, or magnetic storage such as optical discs, storage discs, diskettes, flash drives, or other circuit or system that can supply digital data to processor 34 from which processor 34 can load software, user profiles, image use profiles, image files, and other image information such as image metadata including derived and recorded metadata. In this regard, the content and program data files can comprise, for example and without limitation, software applications, a still image data base, image sequences, a video data base, graphics, and computer generated images, image usage information associated with still, video, or graphic images, user usage profiles, and any other data necessary for practicing embodiments of the present invention as described herein. Source of content data files 24 can optionally include devices to capture images to create image data files by use of capture devices located at electronic computer system 20 and/or can obtain content data files that have been prepared by or using other devices or image enhancement and editing software. In the embodiment of FIG. 31, sources of content or program data files 24 include sensors 38, a memory and storage system 40 and a communication system 54.

Sensors 38 can include one or more cameras, video sensors, scanners, microphones, PDAs, palm tops, laptops that are adapted to capture images and can be coupled to processor 34 directly by cable or by removing portable memory 39 from these devices and/or computer systems and coupling the portable memory to slot 46. Sensors 38 can also include biometric or other sensors for measuring physical and mental reactions. Such sensors including, but not limited to, voice inflection, body movement, eye movement, pupil dilation, body temperature, and p4000 wave sensors.

Memory and storage 40 can include conventional digital memory devices including solid state, magnetic, optical or other data storage devices, as mentioned above. Memory 40 can be fixed within system 26 or it can be removable and portable. In the embodiment of FIG. 31, system 26 is shown having a hard disk drive 42, which can be an attachable external hard drive, which can include an operating system for electronic computer system 26, and other software programs and applications such as the program algorithm embodiments of the present invention, a template design data base, derived and recorded metadata, image files, image attributes, software applications, and a digital image data base. A disk drive 44 for a removable disk such as an optical, magnetic or other disk memory (not shown) can also include control programs and software programs useful for certain embodiments of the present invention, and a memory card slot 46 that holds a removable portable memory 48 such as a removable memory card or flash memory drive or other connectable memory and has a removable memory interface 50 for communicating with removable memory 48. Data including, but not limited to, control programs, template designs, derived and recorded metadata, digital image usage files, user attributes, image attributes, software applications, digital images, and metadata can also be stored in a remote server 52 such as a personal computer, computer network, a network connected server, or other digital system having a memory system for data storage.

In the embodiment shown in FIG. 31, system 26 has a communication system 54 that in this embodiment can be used to communicate with an optional remote input 58, remote server system 52, an optional remote display 56, for example by transmitting image designs in the form of calendar template designs with or without merged images and receiving from remote server system 52, a variety of control programs, template designs, derived and recorded metadata, image files, image attributes, and software applications. Although communication system 54 is shown as a wireless communication system, it can also include a modem for coupling to a network over a communication cable for providing to the computer system 26 access to the network and server system 52. A remote input station including a remote display 56 and/or remote input controls 58 (also referred to herein as “remote input 58”) can communicate with communication system 54 wirelessly as illustrated or, again, can communicate in a wired fashion. In a preferred embodiment, a local input station including either or both of a local display 66 and local user input controls 68 (also referred to herein as “local user input 68”) is connected to processor 34 which is connected to communication system 54 using a wired or wireless connection.

Communication system 54 can comprise for example, one or more optical, radio frequency or other transducer circuits or other systems that convert data into a form that can be conveyed to a remote device such as server 52 or remote display 56 using an optical signal, radio frequency signal or other form of signal. Communication system 54 can also be used to receive a digital image and other data, as exemplified above, from a host or server computer or network (not shown), a server 52 or a remote input 58. Communication system 54 provides processor 34 with information and instructions from signals received thereby. Typically, communication system 54 will be adapted to communicate with the server 52 by way of a communication network such as a conventional telecommunication or data transfer network such as the internet, and peer-to-peer; cellular or other form of mobile telecommunication network, a local communication network such as wired or wireless local area network or any other conventional wired or wireless data transfer system.

User input system 68 provides a way for a user of system 26 to provide instructions to processor 34, such instructions comprising automated software algorithms of particular embodiments of the present invention that automatically generate coordinated image templates according to selected template designs. This software also allows a user to make a designation of content data files, such as selecting calendar templates and designating digital image files, to be used in automatically generating an image enhanced output calendar product according to an embodiment of the present invention and to select an output form for the output product. User controls 68a, 68b or 58a, 58b in user input system 68, 58, respectively, can also be used for a variety of other purposes including, but not limited to, allowing a user to arrange, organize and edit content data files, such as coordinated image displays and calendar image templates, to be incorporated into the image output product, for example, by incorporating image editing software in computer system 26 which can be used to override design automated image output products generated by computer system 26, as described below in certain preferred method embodiments of the present invention, to provide information about the user, to provide annotation data such as text data, to identify characters in the content data files, and to perform such other interactions with system 26 as will be described later.

In this regard user input system 68 can comprise any form of device capable of receiving an input from a user and converting this input into a form that can be used by processor 34. For example, user input system 68 can comprise a touch screen input 66, a touch pad input, a multi-way switch, a stylus system, a trackball system, a joystick system, a voice recognition system, a gesture recognition system, a keyboard 68a, mouse 68b, a remote control or other such systems. In the embodiment shown in FIG. 31, electronic computer system 26 includes an optional remote input 58 including a remote keyboard 58a, a remote mouse 58b, and a remote control 58c. Remote input 58 can take a variety of forms, including, but not limited to, the remote keyboard 58a, remote mouse 58b or remote control handheld device 58c illustrated in FIG. 31. Similarly, local input 68 can take a variety of forms. In the embodiment of FIG. 31, local display 66 and local user input 68 are shown directly connected to processor 34.

As is illustrated in FIG. 32, computer system 26 and local user input system 68 can take the form of an editing studio or kiosk 70 (hereafter also referred to as an “editing area 70”), although this illustration is not intended to limit the possibilities as described in FIG. 32 of editing studio implementations. In this illustration, a user 72 is seated before a console comprising local keyboard 68a and mouse 68b and a local display 66 which is capable, for example, of displaying multimedia content. As is also illustrated in FIG. 32, editing area 70 can also have sensors 38 including, but not limited to, camera or video sensors 38 with built-in lenses 89, audio sensors 74 and other sensors such as, for example, multispectral sensors that can monitor user 72 during a user or production session.

Output system 28 (FIG. 31) is used for rendering images, text, completed or uncompleted digital image templates and other digital image output products, or other graphical representations in a manner that allows an image output product to be generated. In this regard, output system 28 can comprise any conventional structure or system that is known for printing, displaying, or recording images, including, but not limited to, printer 29. For example, in other embodiments, output system 28 can include a plurality of printers 29, 30, 32, and types of printers, including transfer machines capable of screen printing t-shirts and other articles. Processor 34 is capable of sending print commands and print data to a plurality of printers or to a network of printers. Each printer of the plurality of printers can be of the same or a different type of printer, and each printer may be able to produce prints of the same or a different format from others of the plurality of printers. Printer 29 can record images on a tangible surface, such as on, for example, various standard media or on clothing such as a T-shirt, using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology such as in thermal printer 30, drop on demand ink jet technology and continuous inkjet technology. For the purpose of the following discussions, printers 29, 30, 32 will be described as being of a type that generates color images. However, it will be appreciated that this is not necessary and that the claimed methods and apparatuses herein can be practiced with printers 29, 30, 32 that print monotone images such as black and white, grayscale or sepia-toned images.

In certain embodiments, the source of content data files 24, user input system 68 and output system 28 can share components. Processor 34 operates system 26 based upon signals from user input system 58, 68, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit chip, or a series of discrete chip components.

A preferred embodiment of the present invention addresses the automated layout of images within a template with constraints provided by users in response to the automated layout. Hence, it is most applicable to layouts with three or more template openings and three or more received images. The images and template openings can all have different sizes, resolutions, aspect ratios, or orientations that can be adjusted for the best aesthetic effect by the layout method. Note that the desired, resolution and size can also be constrained by the image product type, since very large image products can usefully use large, high-resolution images while smaller image products can use smaller, lower-resolution images. Furthermore, for templates that have defined template openings, it can be useful to change the locations of the defined template openings to accommodate the preferred location of a received image, for example as specified by a user or by the automated layout method. Alternatively or in addition to, the template openings can be adjusted to accommodate desired images, for example by making the openings larger (for example for large images) or small (for example for small images), especially so that images are not printed at a resolution inappropriate to the image size, image product, or intended viewing distance of the image product. Images can also be cropped to accommodate a template or desired layout, either by a user or by an automated tool for determining a main subject and scene content within an image. Any combination of cropping, size modification, resolution modification, orientation modification, or aspect ratio modification can be employed.

Preferred embodiments of the present invention provides advantages over the prior art. In one prior art method, images are positioned in a template by hand, for example by dragging and dropping image icons in a graphic user interface into an illustrated template. This can be very tedious. Alternatively, automated layout methods can be quick but do not always meet the users' expectations. While a user could repeatedly scramble a multi-image product layout and view different layout options, it is difficult to remember the different layouts and to compare their aesthetic value. A user might also re-layout an initial automated layout, but this runs the risk of only optimizing the portion of the imagery re-worked by a user and leaving the remainder untouched and inappropriately arranged.

Preferred embodiments of the present invention provide methods for providing a personalized, optimized multi-media image product efficiently and simply. If multiple images are known to have preferred locations, they can be simply specified at a single stage. In addition, incremental changes can be made to improve the layout over time in a way that the user can readily understand and appreciate by viewing intermediate stages of the process. Undo operations, as are known in the art, can also be employed to assist the user in preventing errors or making mistakes.

The invention has been described in detail with particular reference to certain preferred embodiments thereof, but it will be understood that variations and modifications can be effected within the spirit and scope of the invention.

### PARTS LIST

10 image or multi-media element
12 selected image or multi-media element
13 second selected image or multi-media element
14 selected location
15 second selected location
16 image border
19 image product
20 image layout
21 template layout
21A image product template
22 photo-collage layout
23 storage
24 system
25 two-page template layout
26 system
27 image area
28 system
29 printer
30 printer
32 I/O
34 processor
35 I/O
38 sensor
39 memory
40 storage
42 storage
44 storage
46 comm
48 memory
50 interface
52 server
54 system
56 I/O
58 I/O
58a I/O
58b I/O
58c I/O
66 I/O
68 I/O
68a I/O
68b I/O
70 system
72 user
80 separation distance
81 separation distance
82 separation distance
83 separation distance
84 separation distance
100 provide multi-media product step
105 receive multi-media elements step
110 auto-composite elements into product step
115 display product step
120 receive element selection step
125 receive new element location step
130 composite selected element in new location step
135 auto-composite remaining elements step
140 display product step
145 receive 2nd element selection step
150 receive 2nd new element location step
155 composite 2nd element in new location step
160 auto-composite remaining elements step
165 display product step
170 print product step

1. A computer system comprising:
storage for three or more digital images and for a digital representation of an image product; and
a processor for executing a computer program that automatically digitally places the digital images into different display locations in the digital representation, receives an input for a first selection of one of the digital images, receives an input indicating a new display location for the first selected digital image, automatically digitally places the first selected digital image into the new display location, automatically digitally relocates displaced ones of the remaining digital images into remaining display locations, displays a digital representation of a completed image product on the digital display including displaying the first selected digital image in the new display location, and transmits a stored file that includes the digital representation of the completed image product.

2. The system of claim 1, wherein the three or more digital images includes at least one multi-media image.

3. The system of claim 1, wherein the computer program automatically relocates display locations.

4. The system of claim 1, wherein the computer program further receives an input for a second selection of another displayed digital image, receives an input for an indication of another display location for said another digital image, wherein said another display location is different from the new display location, and automatically digitally places said another digital image into said another display location and automatically digitally relocates displaced ones of the remaining displayed digital images, except for the first selected digital image, into remaining display locations, wherein the digital representation of the completed image product includes said another digital image in said another display location.

5. The system of claim 1, further including a printer connected to the system for printing the digital representation of the completed image product.

6. The system of claim 1, wherein the three or more digital images each comprises a different size, resolution, aspect ratio, or orientation.

7. The system of claim 6, wherein the computer program modifies at least one of the different size, resolution, aspect ratio, or orientation of at least one of the three or more digital images.

8. The system of claim 1, wherein the computer program modifies a resolution, size, aspect ratio, or orientation of the first selected digital image.

9. The system of claim 1, wherein the digital representation of an image product includes a border that is displayed in association with the first selected digital image.

10. The system of claim 9, wherein the computer program displays the border in association with the first selected digital image in the new display location.

11. The system of claim 1, wherein the digital representation of an image product further comprises a template having three or more different display locations for placing the three or more digital images.

12. The system of claim 1, wherein the computer program increases a size of a received cropped digital image by including portions of the received cropped digital image that were previously cropped out of the received cropped digital image.

13. The system of claim 1, wherein the computer program crops at least one of the three or more digital images so that it fits a corresponding one of the display locations.

14. The system of claim 1, wherein the digital representation of the image product includes display locations that overlap.
